(19) United States
(12) Patent Application Publication
(10) Pub. No.: US 2008/0270154 A1
(43) Pub. Date: Oct. 30, 2008

(54) System for scoring click traffic

(76) Inventors: Boris Klots, Belmont, CA (US); Richard T. Chow, Sunnyvale, CA (US); Apurva M. Desai, Fremont, CA (US)

Correspondence Address: BRINKS HOFER GILSON & LIONE / YAHOO! OVERTURE, P.O. BOX 10395, CHICAGO, IL, 60610, US

(21) Appl. No.: 11/789,729

(22) Filed: Apr. 25, 2007

(51) Int. Cl. G06Q 30/00; G07G 1/14

(52) U.S. Cl. 705/1; 705/14

(57) ABSTRACT

A system is disclosed for measuring click traffic quality by scoring clicks made on sponsored advertisements. A click score generated by the disclosed system may enable advertisers and publishers to distinguish between legitimate and fraudulent clicks. The disclosed system may filter click data associated with a click made on a sponsored advertisement. The system may generate a click score that may represent the confidence with which the quality of a click may be determined. The system also may generate a confidence interval associated with the click score.

### BACKGROUND

1. Technical Field

The present description relates generally to fraud detection and, more particularly, but not exclusively, to click-fraud detection in on-line advertising.

2. Related Art

The availability of powerful tools for developing and distributing Internet content has led to an increase in information, products, and services offered through the Internet, as well as a dramatic growth in the number and types of consumers using the Internet. With this increased consumer traffic, the number of advertisers promoting their goods and services through the Internet has also grown dramatically.

Advertisers may pay publishers to host or sponsor their advertisements on Web pages, search engines, browsers, or other online media. Publishers may charge the advertisers on a “per click” basis, meaning the publishers may charge the advertisers each time one of their advertisements is clicked-on. However, the “per click” payment model may be susceptible to click fraud. For example, a script or other software agent may be configured to repeatedly click on an advertisement, artificially driving up the per-click payments and resulting in an advertiser being charged for a large number of fraudulent clicks.

To address the potential for click-fraud, click-based advertisement models may employ click-fraud detection systems to identify “valid” or legitimate clicks. The publisher may then only charge the advertiser for the valid clicks. However, there may not be a standard method for determining whether or not a click is valid. In addition, merely assigning a click to a binary category (e.g., valid or invalid) may not adequately or accurately account for the probabilistic determinations that often characterize click quality. Accordingly, frequent misclassifications may result. In addition, while two clicks may have each been declared valid, the clicks may still include significant differences. Based on the characteristics of the click, one click may have been definitively valid, whereas another may have been a borderline case. Merely declaring each click to be valid may not take into account the relative confidence with which each click was classified.

### BRIEF SUMMARY

A system is disclosed for measuring click traffic quality by scoring clicks on sponsored advertisements. The disclosed system may filter click data associated with a click on a sponsored advertisement. The system may generate a click score that represents the confidence with which the quality of a click may be determined. The system also may generate a confidence interval associated with the click score. A click score generated by the disclosed system may enable advertisers and publishers to distinguish between legitimate and fraudulent clicks.

The system may include multiple filters for generating the filter output data. The filter output data may indicate which of the multiple filters fired in response to the click data. The output data may also include composite filter scores that correspond to the multiple filters. The multiple filters may include one or more definitive filters. A definitive filter may be configured to fire when the click data suggests, with a reasonable level of confidence, that the click is fraudulent. The system may compare the click score to one or more thresholds to obtain a click classification.

Other systems, methods, features, and advantages will be, or will become, apparent to one with skill in the art upon examination of the following figures and detailed description. It is intended that all such additional systems, methods, features, and advantages be included within this description, be within the scope of the invention, and be protected by the following claims.

### BRIEF DESCRIPTION OF THE DRAWINGS

Non-limiting and non-exhaustive descriptions are provided with reference to the following figures. The components in the figures are not necessarily to scale, with an emphasis instead being placed upon illustrating the principles of the invention. Moreover, in the figures, like-referenced numerals designate corresponding parts throughout the different views.

FIG. 1 is a block diagram of a general architecture of a system for adaptive click traffic scoring.

FIG. 2 is a flowchart illustrating a process for scoring a user click in a system for adaptive click traffic scoring.

FIG. 3 is a block diagram of a view of a system for adaptive click traffic scoring, including filtering logic and one or more scoring algorithms.

FIG. 4 is a block diagram illustrating a relationship between a user's intent in clicking on an advertisement and a click score in a system for adaptive click traffic scoring.

FIG. 5 is a flowchart illustrating a process for scoring a user click in the system of FIG. 1 or other systems for adaptive click traffic scoring.

FIG. 6 is a flowchart illustrating a process for applying a threshold to a click score in a system for adaptive click traffic scoring.

FIG. 7 is a flowchart illustrating a process for applying an upper and a lower threshold to a click score in a system for adaptive click traffic scoring.

FIG. 8 is block diagram of a computer system implementing a system for adaptive click traffic scoring.

### DETAILED DESCRIPTION

A system and method, generally referred to as a system, relate generally to click traffic scoring based on filtered click data. The principles described herein may be embodied in many different forms. The disclosed systems and methods may allow publishers and/or advertisers to effectively identify untrustworthy or invalid clicks and/or valid clicks. The disclosed systems and methods may provide a click score that may represent the relative confidence in the validity of the click. The click score may be used to determine the quality of the click. In this manner the disclosed systems and methods may enable a publisher to implement versatile click-based advertisement pricing models. For the sake of explanation, the system is described as used in a network environment, but the system may also operate outside of the network environment.

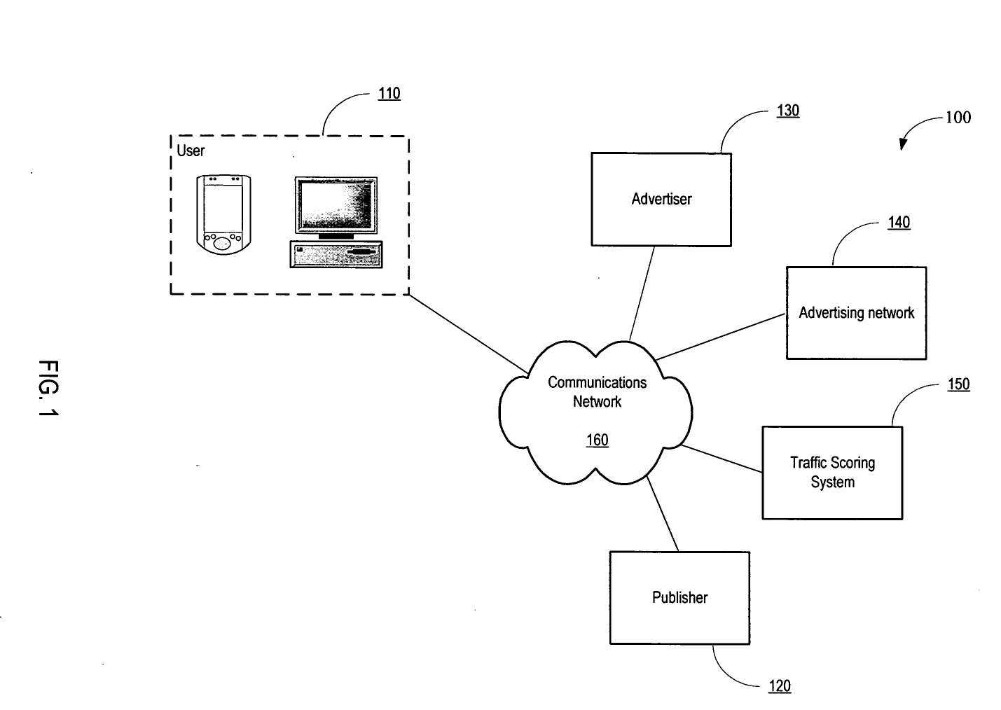

FIG. 1 shows a general architecture 100 of a system for adaptive click traffic scoring. The architecture 100 may include a user client system 100, a publisher 120, an advertiser 130, an advertising network 140, and a click traffic scoring system 150. The user client system 10 may search, browse or otherwise access content, including advertising content, provided by the publisher 120 via a communications network 160. The publisher 120 may host advertising content provided by the advertiser 130, such as on a Web page. The publisher 120 may also display advertising content provided by the advertiser in response to a user query at a search engine. The components of the architecture 100 may be separate, may be supported on a single server or other network enabled system, or may be supported by any combination of servers or network enabled systems. The components of the architecture 100 may include, or access via the communications network 160, one or more databases for storing data, parameters, statistics, programs, Web pages, search listings, advertising content, or other information related to advertising, click traffic scoring, or other systems.

The communications network 160 may be any private or public communications network or combination of networks. The communications network 160 may be configured to couple one computing device, such as a server, system, database, or other network enabled device, to another device, enabling communication of data between the devices. The communications network 160 may generally be enabled to employ any form of computer-readable media for communicating information from one computing device to another. The communications network 160 may include one or more of a wireless network, a wired network, a local area network (LAN), a wide area network (WAN), a direct connection, such as through a Universal Serial Bus (USB) port, and may include the set of interconnected networks that make up the Internet. The communications network 160 may implement any communication method by which information may travel between computing devices.

The publisher may charge the advertiser 130 for hosting advertising content, such as on a Web page, search engine, browser, or other online publishing media. For example, the publisher 120 may charge the advertiser 130 on a per click basis, i.e., each time the advertisement hosted by the publisher 120 is selected by a user. The user client system 100 may select an advertisement by clicking on the advertisement.

The user client system 110 may connect to the publisher 120 via the Internet using a standard browser application. A browser-based implementation allows system features to be accessible, regardless of the underlying platform of the user client system 110. For example, the user client system 110 may be a desktop, laptop, handheld computer, cell phone, mobile messaging device, network enabled television, digital video recorder, such as TIVO, automobile, or other network enabled user client system 110, which may use a variety of hardware and/or software packages. The user client system 110 may connect to the publisher 120 using a stand-alone application (e.g., a browser via the Internet, a mobile device via a wireless network, or other applications) which may be platform-dependent or platform-independent. Other methods may be used to implement the user client system 110.

Selections or clicks on advertisements from a user client system 110 may not always be authentic. A click, or a series of multiple clicks on the same advertisement, may originate from an automated script, rather than from a potential customer.

The click traffic scoring system 150 may generate a click score, as well as a confidence interval associated with the click score to measure the quality of a click. The click score and confidence interval may provide a scoring mechanism that uses a continuous scale, as opposed to a binary mechanism that, for example, only identifies a click as valid/invalid categories. The continuous scale may range from one to N, zero to infinity, or may include other numerical ranges. The click traffic scoring system 150 may calculate the click score and confidence interval based in part on user click data. The publisher 120, or another system that monitors and collects data related to user clicks, may obtain user click data and transmit the user click data to the click traffic scoring system 150 via the communications network 160.

The click traffic scoring system 150 may transmit the click score and confidence interval to the publisher 120, advertiser 130, and/or advertising network 140 via the communications network 160. The advertising network 140 may act as an intermediary between the publisher 120 and the advertiser 130. The publisher 120, advertiser 130, and/or advertising network 140 may implement a versatile advertisement pricing model using the click score and confidence interval. For example, the fee charged to the advertiser for each click may be a function of the click score, where the fee gradually increases as the click score increases. The pricing model may include a tiered pricing model, where different ranges of click scores correspond to different pricing tiers.

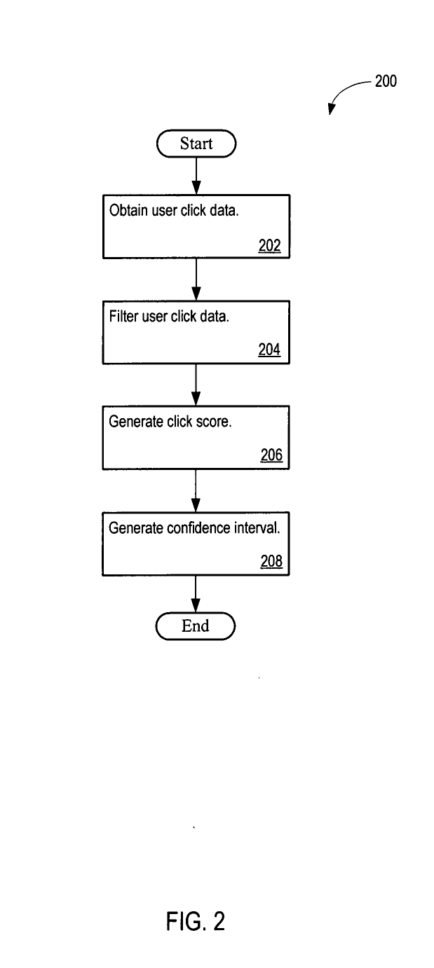

FIG. 2 illustrates the process 200 that may be used to score a user click in a system for adaptive click traffic scoring, such as the click traffic scoring system 150. The process 200 may obtain user click data associated with a user click (Act 202) by monitoring and/or gathering information associated with the click. User click data may include a referring URL, cookie data, an IP address, a geographic location, whether the click was made in response to a query, whether the click was made by an automated script, or other click characteristics. The process 200 may compile the user click data. Alternatively, or in addition, the process 200 may receive user click data compiled by another click monitoring process.

The process 200 may filter the user click data (Act 204). The process 200 may apply the user click data to filtering logic to generate filter output data. The filtering logic may include one or more filters. A filter may be a function designed to identify a certain kind of invalid traffic. The filter output data may indicate which filters fired in response to the user click data. The filter output data may also include filter scores.

A filter may be a deterministic filter, such as a binary function that is “1” for self-declared robots and “0” otherwise. In this example, the filter may be said to fire on a click if the value of the function is not “0.”

A filter may also be a probabilistic filter. For example, a filter may determine whether over a certain period of time a particular advertisement has been targeted by a particular client more often than an average number of clicks for this advertisement. In this example, if a client produced two times more clicks for a particular advertisement than the average, a filter may consider historical analysis or statistics to determine whether the above-average number of clicks represents a random fluctuation as opposed to a fraudulent attack. From a historical analysis, for example, it may be known that clients that produce two times more clicks than an average are fraudulent sixty-percent (60%) of the time, and the result of normal variability forty-percent (40%) of the time. In this case, if the score of a perfect click is 1, the filter may score the click as 0.4 with the confidence interval (0.3, 0.5) corresponding to a confidence level of 90%.

A filter score may include a binary output, representing, for example, whether or not the corresponding filter fired. A filter score may include a fractional number, a range, or other numerical representations, representing, for example, the likelihood that the filtered data corresponds to a valid or invalid click.

The filtering logic may include filters that check specific click characteristics. For example, the filtering logic may include an automated script filter. Such a filter may fire when the click originates from a known automated script as opposed to originating from, for example, a legitimate user search. The filter may also include black lists, including lists obtained from various agencies or organizations, such as the Interactive Advertising Bureau.

The filtering logic may also include an IP address filter. The IP address filter may fire when the IP address from which the click originated suggests the click is invalid. The IP address filter may include algorithms, look-up functions, or other processing techniques such as by comparing the IP address from which the click originated to a list or database of bad or “blacklisted” IP addresses. The filter score provided by the IP address filter may be a simple “1” or “0,” representing whether or not the filter fired and therefore whether the click is valid or invalid.

An IP address filter may also output a fractional or other numerical filter score representing the confidence with which click traffic from a certain IP address can be deemed valid or invalid. For example, a proxy server X may be known to contain seventy-percent (70%) of valid traffic and thirty-percent (30%) of invalid traffic. In this example, if the score of a perfect click is 1, the filter may provide a score of 0.7 for a click from proxy server X.

Alternatively, or in addition, the filtering logic may include filters that correspond to one or more geographic locations. The geographic location filter may provide a filter score that may represent the confidence level in declaring a click invalid based on the geographic location the click originated from. The geographic location of the user may be identified by analyzing the IP address, implementing various geo-coding techniques, or by other geographic locating methods. The geographic location filter may include or may access data associated with the identified geographic location, such as statistical or extrapolated data that indicates the likelihood that a click is valid or invalid for a given location.

The filtering logic may include other filters that fire when a click possesses, or lacks, certain characteristics. The types of click characteristics the process 200 may watch for, i.e., the types of filters used, may be adapted to the requirements of a publisher or an advertiser. The types of characteristics filtered by the process 200 may also be obtained from other sources of information, such as standards set forth by the Internet Advertising Bureau or by other associations or organizations.

When a filter or combination of filters fire, the process 200 may determine a filter score using statistical data, including conversion rates for the filters or combinations of filters that fired in response to the user click data. Let S be the population of clicks, and let s represent an element of S. The element s may include one or more click characteristics, including the IP address, referring URL, cookie data, or other click characteristics. Let F be a subset of S on which the filter or combination of filters fire. F can be expressed as a binary function on S, i.e. F(s)=1 on the subset of S on which the filter or combination of filters fire, and F(s)=0 otherwise. Then, the effectiveness, or score of the filter, or of the combination of filters, may be estimated by the ratio

$$\frac{Pr ( s valid \text{\textbar} F ( s ) = 1 )}{Pr ( s valid )} ,$$

where s belongs to the set S of clicks, and where the numerator denotes the probability of a valid click given that the click lies in F and the denominator denotes the probability of a valid click over the entire space S. A good subset F, i.e., a subset that effectively identifies an invalid click with minimal misclassifications, may have a ratio close to zero. The subset F may correspond to a filter or a combination of filters.

A click leads to conversion, or may be “converted,” when the click has led to a desired action defined by an advertiser. An advertiser may define conversion as when a click leads to an actual purchase. Alternatively, or in addition, a click may lead to conversion when the click results in a user adding an item to a “shopping cart,” regardless of whether the user ultimately purchases the item. In other words, the criteria for conversion may be determined by an advertiser and may vary among advertisers.

The ratio

$$\frac{Pr ( s valid \text{\textbar} F ( s ) = 1 )}{Pr ( s valid )}$$

may be estimated using observed, compiled, or collected statistical click conversion data, by making the assumption that conversion and F are conditionally independent, given validity. Two events, A and B, are conditionally independent given a third event C if the occurrence of A does not change the probability of B occurring, and visa versa. In other words, if a click is known to be valid, the occurrence of conversion does not change the probability that the click falls within subset F, and vice versa. That is, the conversion rate for valid clicks may not change when restricted to the set {F(s)=1}. Based on this assumption of conditional independence, the ratio

$$\frac{Pr ( s converted \text{\textbar} F ( s ) = 1 )}{Pr ( s converted )}$$

may be used as a measure of

$$\frac{Pr ( s valid \text{\textbar} F ( s ) = 1 )}{Pr ( s valid )} .$$

The ratio

$$\frac{Pr ( s converted \text{\textbar} F ( s ) = 1 )}{Pr ( s converted )}$$

may further be estimated with the following assumptions:

1. The support of F likely makes up a small portion of S. In other words, Pr(s convergent)≈Pr(s convergent|F(s)=0). Accordingly,

$$\frac{Pr ( s converted \vert F ( s ) = 1 )}{Pr ( s converted )}$$

may be estimated as

$$\frac{Pr ( s converted \vert F ( s ) = 1 )}{Pr ( s converted \vert F ( s ) = 0 )} .$$

2. Click conversion may be modeled as independent Bernoulli trials for each click, i.e., for each click there may be a sample space {converted, not converted}, as well as associated probabilities pₛ and 1−pₛ. The probability pₛ may be the likelihood that a click s is converted. For any subset A of S, the quantity Pr(s convergent|A) may be the average of all pₛ with s in A.

For a subset F, let p_{D} be Pr(s converted|F(s)=1) and p_{C} be Pr(s converted|F(s)=0). Then the ratio

$$\frac{{p}_{D}}{{p}_{C}}$$

may estimate subset F's effectiveness in identifying an invalid click. The ratio

$$\frac{{p}_{D}}{{p}_{C}}$$

may also correspond to a filter score for subset F.

The ratio

$$\frac{{p}_{D}}{{p}_{C}}$$

may also correspond to the click score discussed below, such as when the subset F corresponds to the combination of filters that fired in response to the user click data. The smaller the ratio

$$\frac{{p}_{D}}{{p}_{C}}$$

for subset F is (i.e., p_{C} larger than p_{D}), the greater the confidence with which the process 200 may determine that a click falling within subset F (or causing a filter that corresponds to subset F to fire) may be invalid. Where subset F corresponds to a combination of filters that fired in response to a click, a smaller ratio of

$$\frac{{p}_{D}}{{p}_{C}}$$

corresponds to a greater confidence that the click that caused the combination of filters to fire is invalid. The values of p_{D} and p_{C} may be obtained from sample data. The sample data may consist of experimental or statistically compiled values for C (and thus p_{C} ) and for D (and thus p_{D}).

The process 200 may analyze the filter output data, including filter scores, to generate a click score (Act 206). As explained above, the filter output data may include multiple filter scores generated by the filters that make up the filtering logic. The process 200 may apply the filter output data to one or more scoring algorithms to calculate the click score. The scoring algorithms may calculate the click score using a variety of techniques.

The scoring algorithm may monitor which filters fired in response to the user click data. The scoring algorithm may determine the click score based on the filter scores that correspond to the combination of filters that fired in response to the user click data. For example, the user click data may cause a certain combination of filters to fire. The click score may be calculated by comparing the conversion rate on the set of clicks filtered by this combination against an overall conversion rate, e.g., by calculating the ratio

$$\frac{{p}_{D}}{{p}_{C}}$$

for subset F. In this example, subset F may be the set of clicks that correspond to the combination of filters that fired in response to the user click data. The scoring algorithm may use statistical data, including conversion rates for various combinations of the filters that fired, to calculate the ratio

$$\frac{{p}_{D}}{{p}_{C}} .$$

The statistical data, including conversion rates, may be stored on a database accessible via a communications network, such as the communications network 160. The statistical data, including conversion rates, may also be provided by a publisher, advertiser, or advertising network.

The scoring algorithms may also average or aggregate the filter scores to obtain the click score. The scoring algorithms may apply weights to the filter scores to enable the results from different filters to impact the continuous score differently. The scoring algorithm may also set the click score to be equal to, or substantially equal to, the filter score having the largest magnitude.

The scoring algorithms may be algorithms generated from neural networks or other learning or pattern recognition algorithms to calculate the click score. For example, the scoring algorithms may be generated from neural networks trained on known data related to click traffic, including click conversion rates, conversion counts, and other click conversion statistics, as well as data related to monitored false positives or false negatives of past clicks.

The process 200 may generate a confidence interval associated with the click score (Act 208). The process 200 may apply the click score and/or the filter output data to the scoring algorithm to generate the confidence interval. The algorithms for calculating the click score may be the same or different algorithms for calculating the confidence interval.

The process 200 may generate a confidence interval associated with p_{D}, p_{C}, and/or the ratio

$$\frac{{p}_{D}}{{p}_{C}}$$

for subset F. Subset F may correspond to the combination of filters that fired in response to the user click data. The process 200 may use Fieller's Theorem to generate an approximate confidence interval for

$$\frac{{p}_{D}}{{p}_{C}} .$$

For a given confidence level, say 1−α, the process may also generate a confidence interval for

$$\frac{{p}_{D}}{{p}_{C}}$$

of the form

$$( \frac{{\overline{p}}_{D} - η}{{\overline{p}}_{C} + λ} , \frac{{\overline{p}}_{D} + η}{{\overline{p}}_{C} - λ} ) .$$

Given sample data of p̅_{D} and p̅_{C}, and a confidence level of 1−α, confidence intervals at level \sqrt{1−α} for p_{D} and p_{C} may be obtained: ( p̅_{D}−η, p̅_{D}+η) and ( p̅_{C}−λ, p̅_{C}+λ) respectively. p_{D} and p_{C} may be independent and, accordingly, the ratio

$$\frac{{p}_{D}}{{p}_{C}}$$

may be in the interval

$$( \frac{{\overline{p}}_{D} - η}{{\overline{p}}_{C} + λ} , \frac{{\overline{p}}_{D} + η}{{\overline{p}}_{C} - λ} )$$

with a confidence level of 1−α.

The click score and/or confidence interval may be transmitted to a publisher, advertiser, advertising network, or other system for calculating advertising fees. The click score may provide an indication of the confidence with which a click may be deemed valid or invalid. The publisher, advertiser, or other system may use the confidence information to tailor an advertisement fee structure to the relative trustworthiness of each click or set of clicks. The confidence interval may provide additional relevant information to the publisher, advertiser, or other system, including the strength, margin of error, or other characteristics of the click score.

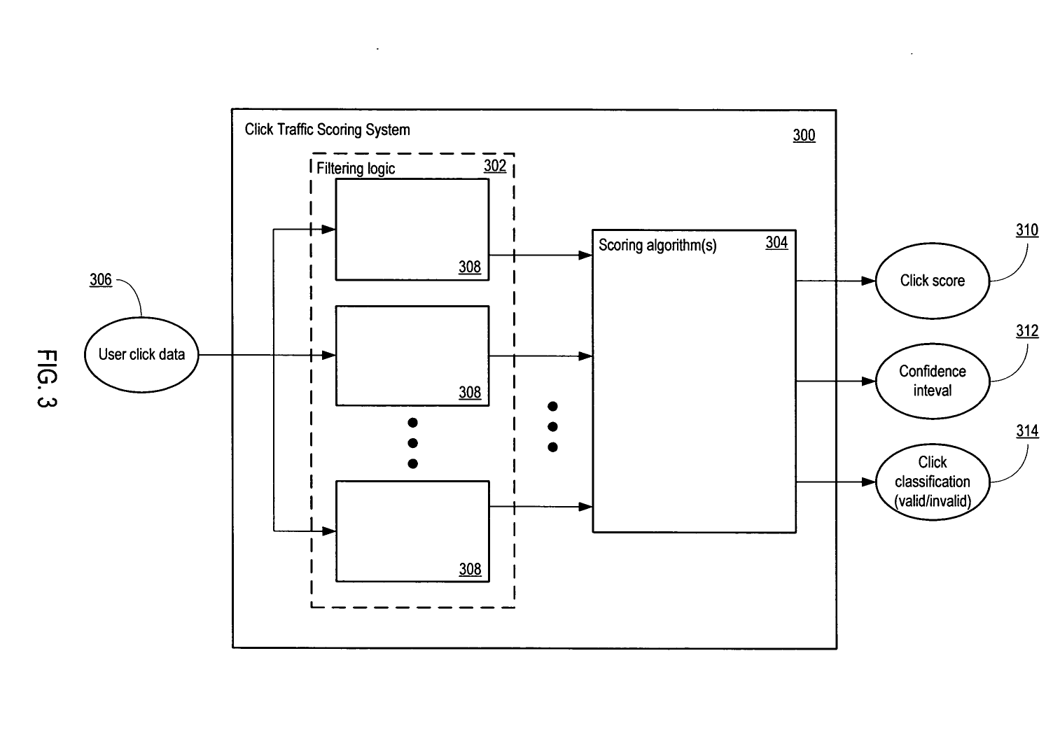

FIG. 3 shows a view of a click traffic scoring system 300 including filtering logic 302 and one or more scoring algorithms 304. The click traffic scoring system 300 may receive user click data 306 that includes information related to the click to be scored. The click traffic scoring system 300 may obtain the user click data 306 from a publisher. The click traffic scoring system 300 may also include a click monitoring system for monitoring user clicks and extracting user click data 306 associated with the user click. User click data 306 may include a referring URL, cookie data, an IP address, a geographic location, whether the click was made in response to a query, whether the click was made by an automated script, or other click characteristics.

The filtering logic 302 may include one or more filters 308 for processing the user click data 306. The click traffic scoring system 300 may pass user click data 306 to the filtering logic 302. The filter logic 302 may generate filter output data based on the user click data 306. The filter output data may include information indicating which combinations of filters fired in response to the user click data. The filter output data may also include filter scores that correspond to outputs generated by individual filters 308, or by combinations of individual filters 308.

The click traffic scoring system 300 may apply the filter output data to the scoring algorithms 304 to generate a click score 310 and a confidence interval 312. The scoring algorithms 304 may also generate one or more click classifications 314. The click score 310 may be a numerical value falling within a continuous numerical range and may represent the relative confidence with which the click's trustworthiness may be determined. The confidence interval 312 corresponds to the click score and may provide additional confidence data related to the click.

The click classification 314 may include one or more classifications assigned to the click based on the filter output data, click score, and/or confidence interval. The click classification 314 may indicate whether the click is valid or invalid. The scoring algorithms 304 may apply one or more thresholds to the click score or to the confidence interval to classify the click as valid or invalid. The scoring algorithms 304 may include pattern recognition algorithms for identifying patterns in the filter output data and for classifying the click according to the recognized pattern. Alternatively or in addition the scoring algorithms 304 may be algorithms generated from neural networks, including trained neural networks.

One or more of the click score 310, confidence interval 312, and click classification 314 may be used by an online publisher, advertising network, or other system to determine which clicks an advertiser should be charged for. In providing a click score 310, the system 200 may enable the publisher or other system to implement a more robust or versatile pricing model. For example, the fee paid per click by the advertiser may be a function of the click score 310. Accordingly, the fee per click may vary according to the relative confidence indicated by the click score.

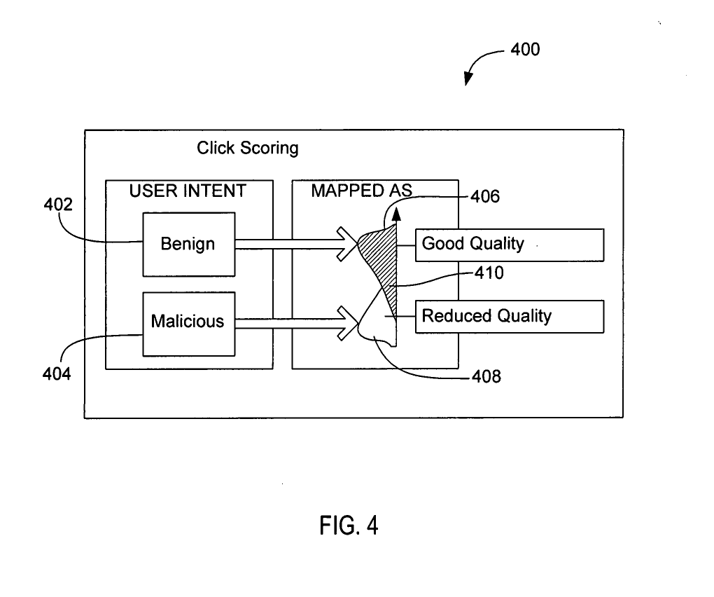

FIG. 4 shows a diagram 400 illustrating a relationship between a user's intent in clicking on an advertisement and a click score generated by a scoring system, such as the click traffic scoring system 150. The user's intent may include benign intent 402 (e.g., an interested consumer) and malicious intent 404 (e.g., an automated script). User click data may include information related to a user's click. The disclosed systems and methods may generate a click score based on user click data, such as by through the process 200 discussed above. The click score may be calculated as a numerical value falling within a numerical range. In the diagram 400, a higher click score corresponds to a higher confidence that a click is a good quality click. A lower click score corresponds to a lower confidence that a click is a good quality click, or put another way, a lower click score corresponds to a greater confidence that a click is a reduced quality click.

The good quality distribution curve 406 represents an exemplary distribution of click scores corresponding to clicks made with benign user intent 402. The reduced quality distribution curve 408 represents an exemplary distribution curve of click scores corresponding to clicks made with malicious or fraudulent user intent 404. The substantial disparity between the good quality distribution curve 406 and the reduced quality distribution curve 408 represents that the click score may effectively and accurately reflect user intent while capturing the relative confidence with which a click's quality may be determined. Two clicks corresponding to click scores that fall within the good quality distribution curve 406 may each be identified as valid. However, determining the point along the distribution curve 406 at which the click score falls may indicate the confidence or strength of the validity identification.

In addition, providing a click score may enable a publisher or other system to distinguish, and thus treat differently, a “close call” click from an “obviously valid” click. A “close call” click may correspond to a click that falls within the overlapping portion 410 of the distribution curves 406 and 408. A “definitively valid” click may correspond to a click that falls within the large portion of the distribution curve 406.

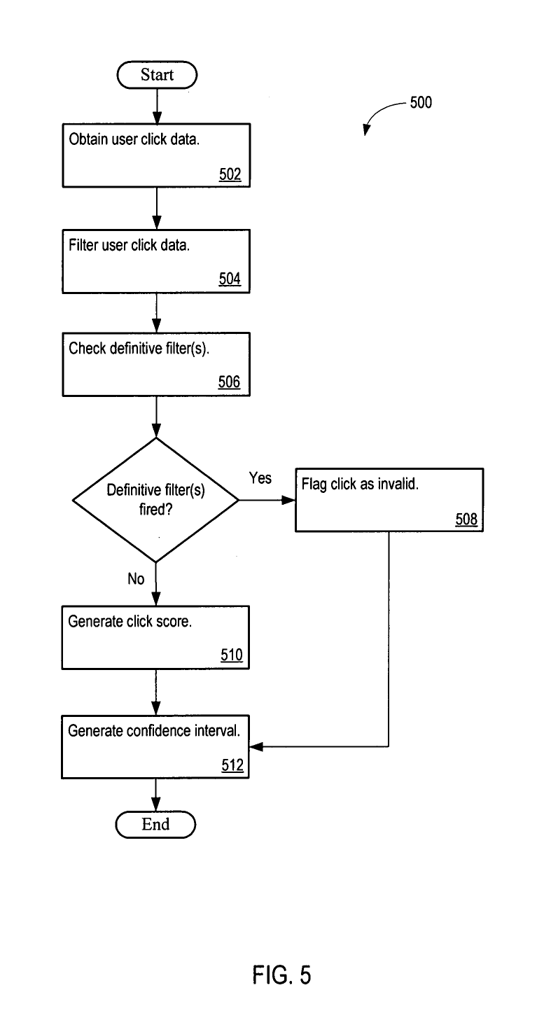

FIG. 5 illustrates a process 500 for scoring a user click in a system for adaptive click traffic scoring, such as the click traffic scoring system 150. The process 500 may obtain user click data (Act 502). The process 500 may obtain the user click data from a publisher. The process 500 may also include a click monitoring step for monitoring user clicks and extracting user click data associated with the user click. User click data may include a referring URL, cookie data, an IP address, a geographic location, whether the click was made in response to a query, whether the click was made by an automated script, or other click characteristics.

The process 500 may filter the user click data to obtain filter output data (Act 504). The process 500 may check whether one or more definitive filters fired (Act 506). If one or more definitive filters have fired, the process 500 may flag the click as invalid (Act 508). A definitive filter may be a filter that fires when a click includes a certain characteristic, or a certain combination of characteristics, that suggest with a high level of confidence that the click may be invalid.

For example, an automated script filter, which may fire when a click originates from a known automated script, may be set as a definitive filter. The validity of a click that originates from a known automated script may be questionable. Accordingly, when an automated script filter fires, the process 500 may confidently declare the click to be invalid even before calculating a click score.

A definitive filter may also include a combination of filters. In this instance, the process 500 may declare the click invalid when a certain combination of filters fire. In other words, a click may include several suspicious click characteristics, each of which may not be definitive of invalidity on their own, but the cumulative effect may be definitive of invalidity.

The definitive filters described above may be characterized as “negative” definitive filters, i.e., when they fire, the click is declared invalid. The process 500 may also employ “positive” definitive filters. There may be certain click characteristics that, if detected, suggest that a click may be declared valid with a high level of confidence.

When no definitive filters have fired, the process 500 may proceed to generate a click score (Act 510) and confidence interval (Act 512). When the process declares a click invalid according to Act 508, the process may still calculate the click score and the confidence interval associated with the click score. The click classification of “invalid” and/or the click score and confidence interval may be transmitted to a publisher, advertiser, advertising network, or other system. The click classification may provide additional information that the publisher or other system may use to configure an advertisement fee structure.

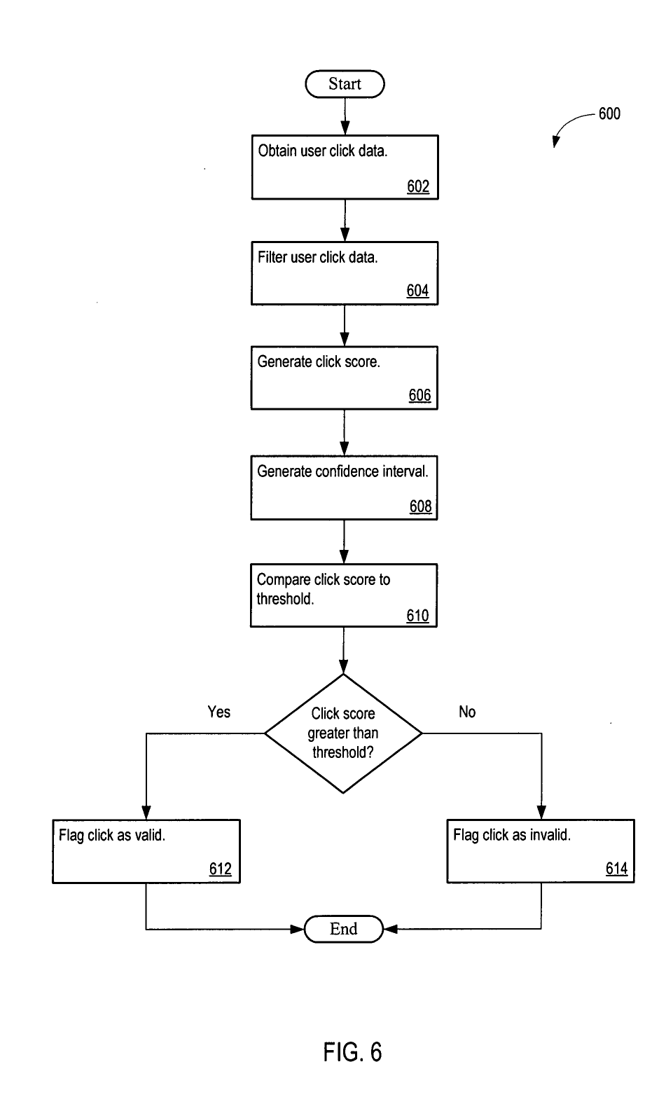

FIG. 6 illustrates a process 600 for applying a threshold to a click score in a system for adaptive click traffic scoring, such as the click traffic scoring system 150. The process 600 may obtain user click data associated with one or more clicks (Act 602). The process 600 may obtain the user click data from a publisher. The process 600 may also include a click monitoring step for monitoring user clicks and extracting user click data associated with the user click. User click data may include a referring URL, cookie data, an IP address, a geographic location, whether the click was made in response to a query, whether the click was made by an automated script, or other click characteristics.

The process 600 may apply the user click data to filtering logic to obtain filter output data (Act 604). The filter output data may include filter scores. The process 600 may generate a click score and a confidence interval based on filter output data (Acts 606 and 608).

The process 600 may compare the click score to a threshold (Act 610). The threshold may be a validity threshold. If the click score exceeds the validity threshold, the process 600 may classify the click as “valid” (Act 612). Otherwise, the process 600 may classify the click as “invalid” (Act 614).

The process 600 may compare the higher endpoint of the click score confidence interval to a threshold. The threshold may be a validity threshold. If the higher endpoint of the click score confidence interval exceeds the validity threshold, the process 600 may classify the click as “valid” (Act 612). Otherwise, the process 600 may classify the click as “invalid” (Act 614).

The valid/invalid classifications, as well as the click score and confidence intervals may be transmitted to a publisher, advertising network, advertiser, or other system. The threshold used to distinguish valid from invalid clicks may be calculated or extrapolated based on statistical data, or may be manually set according to the needs or requirements of the publisher, advertiser, advertising network, or other system.

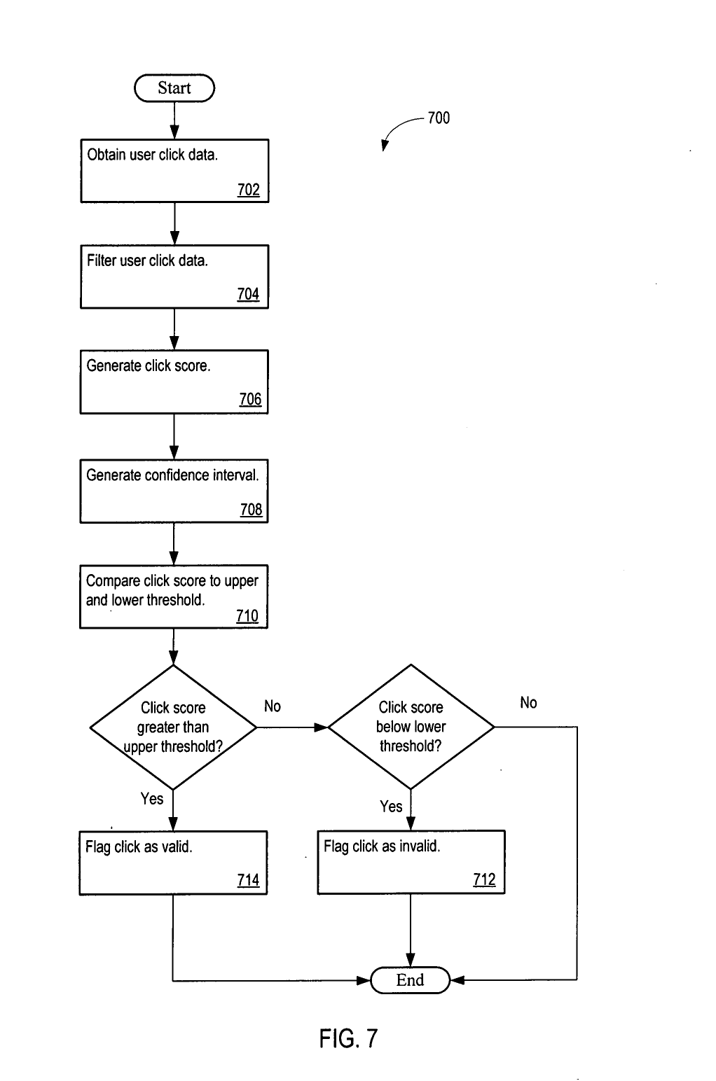

FIG. 7 illustrates a process for applying an upper and a lower threshold to a click score in a system for adaptive click traffic scoring, such as the click traffic scoring system 150. Similar to the process 600 shown in FIG. 6, the process 700 may obtain a user click data (Act 702) and may apply the user click score to filtering logic to obtain filter output data (Act 704). The process 700 may obtain the user click data from a publisher. The process 700 may also include a click monitoring step for monitoring user clicks and extracting user click data associated with the user click. User click data may include a referring URL, cookie data, an IP address, a geographic location, whether the click was made in response to a query, whether the click was made by an automated script, or other click characteristics. The process 700 may generate a click score (Act 706) and a confidence interval (Act 708) based on the filter output data.

The process 700 may compare the click score against an upper score threshold and a lower score threshold (Act 710). When the click score exceeds the upper click threshold, the process 700 may classify the click as “valid” (Act 712). When the click score is below the lower click threshold, the process 700 may classify the click as “invalid” (Act 714). When the click score is neither greater than the upper click threshold nor less than the lower click threshold, the click may be in a “grey area.” The process 700 may provide the publisher, advertising network, advertiser, or other system with the click score and confidence interval. The valid/invalid classifications may be provided to a publisher, advertising network, advertiser, or other system in addition to or instead of the click score and confidence interval.

The process 700 may also use endpoints of confidence intervals for the click score to compare against score thresholds. For instance, if the upper endpoint of the click score confidence interval is below the lower click threshold, the click may be marked “invalid.”

The upper and lower click thresholds may be set manually, such as by the publisher, advertising network, advertiser, or other system. Alternatively, or in addition, the upper and lower click thresholds may be obtained from statistical data provided by a publisher or other system. The process 700 may use different upper and lower thresholds for different filters or combinations of filters. For example, the process 700 may identify the filter or combination of filters that fired in response to user click data and tailor the upper and lower thresholds to that filter or combination of filters. The upper and lower thresholds may be values extrapolated from experimental or statistical data. The upper and lower thresholds may also be calculated by learning or by trained algorithms, such as neural networks.

The disclosed methods, processes, programs, and/or instructions may be encoded in a signal-bearing medium, a computer-readable medium such as a memory, programmed within a device such as on one or more integrated circuits, or processed by a controller or a computer. If the methods are performed by software, the software may reside in a memory resident to or interfaced to a communication interface, or any other type of non-volatile or volatile memory. The memory may include an ordered listing of executable instructions for implementing logical functions. A logical function may be implemented through digital circuitry, through source code, through analog circuitry, or through an analog source such as that occurring through an analog electrical, audio, or video signal. The software may be embodied in any computer-readable or signal-bearing medium, for use by, or in connection with, an instruction executable system, apparatus, or device. Such a system may include a computer-based system, a processor-containing system, or another system that may selectively fetch instructions from an instruction executable system, apparatus, or device that may also execute instructions.

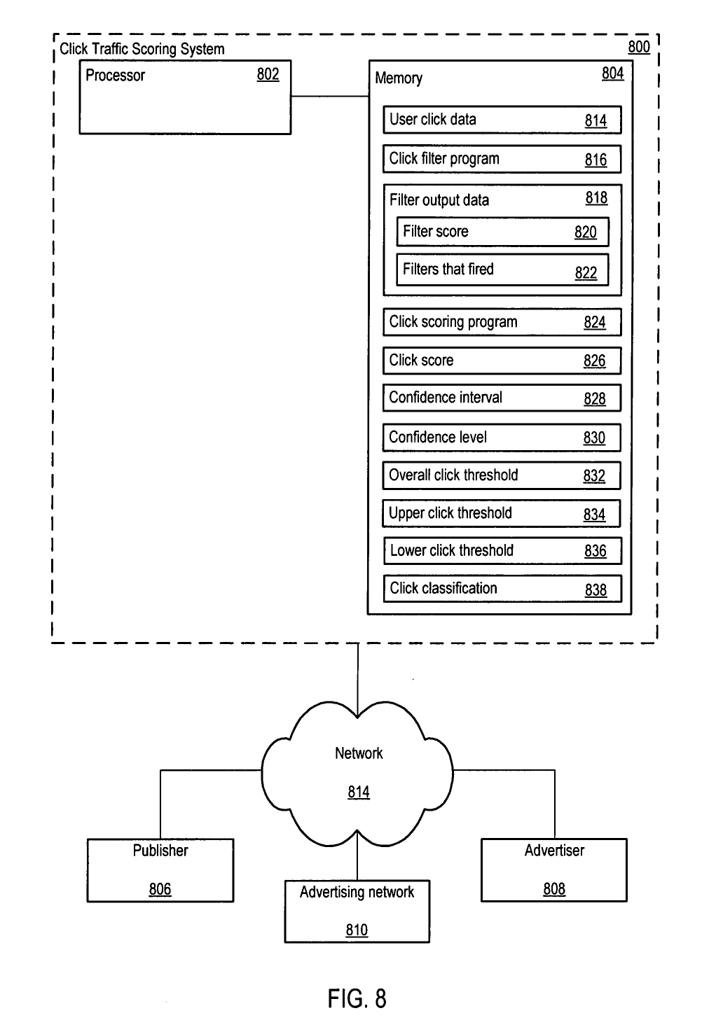

FIG. 8 illustrates a computer system implementing a click traffic scoring system 800, including a processor 802 coupled to a memory 804. The processor 802 may execute instructions stored on the memory 804 to score click traffic. The click traffic scoring system 800 may communicate with a publisher 806, advertiser 808, and/or advertising network 810 via a communications network 812.

The memory 804 may store user click data 814 associated with a click. User click data 814 may include a referring URL, cookie data, an IP address, a geographic location, whether the click was made in response to a query, whether the click was made by an automated script, or other click characteristics. The user click data 814 may be obtained by monitoring and/or gathering information associated with the click. The processor 802 may execute a click filter program 814 stored on the memory 804. The click filter program 816 may apply the user click data 814 to one or more filters to generate filter output data 818. The filter output data 818 may include one or more filter scores 820. The filter output data 818 may include an identification 822 of which filters fired in response to the user click data 814.

The processor 802 may execute a click scoring program 824 stored on the memory 804. The click scoring program 824 may generate a click score 826 and confidence interval 828 based on the filter output data 818. The click score 826 may be a numerical value representing the confidence with which a click's quality may be determined. The click scoring program 824 may determine the confidence interval 828 and the click score 826 based in part on a confidence level 830. The click scoring program 824 may include a default confidence level, such as a default of 95%. The click scoring program 824 may adjust the confidence level 830 to the needs or requirements of the publisher 806, advertiser 808, or advertising network 810.

The click scoring program 830 may also apply thresholds 832-836 stored on the memory 804 to the click score 826 and/or confidence interval 828 to generate a click classification 838. The click classification 838 may include information related to whether the click is valid or invalid. The thresholds 832-836 may be a validity threshold 832, an upper click threshold 834, and/or a lower click threshold 836.

From the foregoing, it may be seen that a click traffic scoring system may provide an improved determination of click quality by scoring clicks with a click score. The click score may enable a publisher or other system to determine, with improved confidence, whether a click may be genuine and billed to the relevant advertiser. In providing a click score, the click traffic scoring system may further enable a publisher, advertiser, advertising network, and/or other system to tailor an advertisement pricing model, such as through a tiered pricing model, to the needs or requirements of the advertiser and publisher.

Although selected aspects, features, or components of the implementations are depicted as being stored in memories, all or part of the systems, including the methods and/or instructions for performing such methods consistent with the click traffic scoring system, may be stored on, distributed across, or read from other computer-readable media, for example, secondary storage devices such as hard disks, floppy disks, and CD-ROMs; a signal received from a network; or other forms of ROM or RAM either currently known or later developed.

Specific components of the click traffic scoring system 150 may include additional or different components. A processor may be implemented as a microprocessor, microcontroller, application specific integrated circuit (ASIC), discrete logic, or a combination of other types of circuits or logic. Similarly, memories may be DRAM, SRAM, Flash, or any other type of memory. Parameters (e.g., popularity rankings), databases, and other data structures may be separately stored and managed, may be incorporated into a single memory or database, or may be logically and physically organized in many different ways. Programs or instruction sets may be parts of a single program, separate programs, or distributed across several memories and processors.

A “computer-readable medium,” “machine-readable medium,” “propagated-signal” medium, and/or “signal-bearing medium” may comprise any means that contains, stores, communicates, propagates, or transports software for use by or in connection with an instruction executable system, apparatus, or device. The computer-readable medium may selectively be, but is not limited to, an electronic, magnetic, optical, electromagnetic, infrared, or semiconductor system, apparatus, device, or propagation medium. A non-exhaustive list of examples of a machine-readable medium may include: an electrical connection “electronic” having one or more wires, a portable magnetic or optical disk, a volatile memory such as a Random Access Memory “RAM” (electronic), a Read-Only Memory “ROM” (electronic), an Erasable Programmable Read-Only Memory (EPROM or Flash memory) (electronic), or an optical fiber (optical). A computer-readable medium may also include a tangible medium upon which software is printed, as the software may be electronically stored as an image or in another format (e.g., through an optical scan), then compiled, and/or interpreted, or otherwise processed. The processed medium may then be stored in a computer and/or machine memory.

While various embodiments of the invention have been described, it will be apparent to those of ordinary skill in the art that many more embodiments and implementations may be possible within the scope of the invention. Accordingly, the invention is not to be restricted except in light of the attached claims and their equivalents.

1. A method for scoring a user click, comprising:
obtaining a user click data associated with the user click;
applying the user click data to multiple filters;
identifying a filter combination, where the filter combination comprises the filters from among the multiple filters that fired in response to the user click data;
generating a click score in accordance with the user click data and the identification of which of the multiple filters fired in response to the user click data; and
generating a confidence interval associated with the click score.

2. The method of claim 1, where generating a click score comprises:
generating filter output data, where the filter output data is generated in accordance with the user click data; and
applying the filter output data to a scoring algorithm to generate the click score.

3. The method of claim 1, where the multiple filters comprise an automated script filter that fires when the user click is made by an automated script.

4. The method of claim 1, where the multiple filters comprise a definitive filter.

5. The method of claim 1, where generating a click score further comprises:
obtaining a first conversion data that comprises click conversion rates associated with the filter combination;
obtaining a second conversion data that comprises click conversion rates associated with the multiple filters; and
comparing the first conversion data against the second conversion data.

6. The method of claim 5, where comparing the first conversion data against the second conversion data comprises determining the ratio of the first conversion data to the second conversion data.

7. The method of claim 1, further comprising:
comparing the click score to a threshold; and
classifying the click as valid when the click score exceeds the threshold.

8. The method of claim 7, where the click score indicates the confidence with which the user click is classified.

9. The method of claim 1, further comprising implementing an advertising pricing scheme based on the click score.

10. The method of claim 1, where the pricing scheme is a tiered pricing scheme.

11. A click traffic scoring system for scoring a user click, comprising:
a processor; and
a memory coupled to the processor, the memory comprising:
a user click data providing information related to the user click;
a click filter program comprising instructions that cause the processor to:
apply the user click data to multiple filters; and
generate a filter output data based on the user click data; and
a scoring program comprising instructions that cause the processor to apply the filter output data to a scoring algorithm to generate a click score based on the filter output data.

12. The system of claim 11, where the scoring program further comprises instructions that cause the processor to generate a confidence interval based on the filter output data.

13. The system of claim 11, where the scoring program further comprises instructions that cause the processor to identify a filter combination, where the filter combination comprises filters that fired in response to the user click data.

14. The system of claim 13, where the scoring program further comprises instructions that cause the processor to:
obtain a first conversion data that comprises click conversion rates associated with the combination of filters;
obtain a second conversion data that comprises click conversion rates associated with the multiple filters; and
compare the first conversion data against the second conversion data.

15. The system of claim 11, where the multiple filters comprise a first filter that corresponds to a first click characteristic, and where the first filter fires when the user click comprises the first click characteristic.

16. The system of claim 13, where the multiple filters include a definitive filter.

17. The system of claim 16, where the click scoring program further includes instructions that cause the processor to classify the user click as invalid when the definitive filter fires.

18. A product, comprising:
a computer-readable medium; and
programmable instructions stored on the computer readable medium that cause a processor in a click traffic scoring system to:
obtain a user click data associated with a user click;
apply the user click data to multiple filters that generate a filter output data, where the filter output data comprises an identification of which of the multiple filters fired in response to the user click data; and
apply the filter output data to a scoring algorithm that generates a click score and a confidence interval associated with the click score, where the click score represents the quality of the user click.

19. The product of claim 18, where the programmable instructions stored on the computer-readable medium cause the processor to:
compare the click score to an upper threshold and to a lower threshold;
classify the user click as invalid when the click score is below the lower threshold; and
classify the user click as valid when the click score exceeds the upper threshold.

20. The product of claim 18, where multiple filters comprise a definitive filter.

21. The product of claim 20, where the programmable instructions stored on the computer readable medium cause the processor to:
determine whether the user click data caused the definitive filter to fire; and
classify the user click as invalid when the definitive filter fires.

22. The product of claim 18, where the confidence interval is generated in accordance with a confidence level.

23. The product of claim 18, where the scoring algorithm is a neural network.

24. The product of claim 18, where the scoring algorithm generates a click score along a continuous numerical range.
